(19) United States
(12) Patent Application Publication
(10) Pub. No.: US 2010/0131523 A1
(43) Pub. Date: May 27, 2010

(54) MECHANISM FOR ASSOCIATING DOCUMENT WITH EMAIL BASED ON RELEVANT CONTEXT

(76) Inventors: Leo Chi-Lok Yu, Shanghai (CN); Wei Xue, Shanghai (CN); Xianyao Pan, Shanghai (CN); Yizhen Yang, Shanghai (CN); Chunsen Chen, Shanghai (CN)

Correspondence Address: SAP/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/277,978

(22) Filed: Nov. 25, 2008

(51) Int. Cl. G06F 17/30; G06F 15/16; G06F 7/00

(52) U.S. Cl. 707/756; 709/206; 707/E17.014; 707/E17.017

(57) ABSTRACT

A mechanism for associating a remote document with an email based on user behaviors is described herein. According to one embodiment, an email context is extracted from a current email being accessed by a user, the email context including one or more attributes representing certain characteristics of the current email. A related context having a list of one or more documents is automatically presented that are related to the current email based on at least one attribute of the email context. The one or more documents are associated with a prior email having certain characteristics that are similar to those represented by at least one attribute of the email context. Other methods and apparatuses are also described.

### COPYRIGHT NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to enterprise computing. More particularly, this invention relates to associating a remote document with an email based on the most relevant context by a relationship network of users, emails, and documents.

### BACKGROUND

Today, email communication becomes a daily activity to help people to communicate, exchange, and collaborate on ideas. On the other hand, most of the enterprise information system (e.g. Business Objects Enterprise) is based on a multi-tier architecture, which generates and stores data on a server repository. Under this approach, an email inbox on a client machine and the data stored in a server repository are disconnected. Thus, a user needs to leave the email client in order to access another application to find the relevant data over and over again when the user is reading the same email, which is time-consuming and may impact productivity.

For example, when a person reads or writes an email, he or she may need to reference a related document stored remotely for reference. During subsequent communication of the same/another email thread, the person may need to repeatedly reference the same piece of information remotely over and over again. There has been a lack of an efficient mechanism for a user to refer to an associated document while accessing an email.

### SUMMARY OF THE DESCRIPTION

A mechanism for associating a remote document with an email based on user behaviors is described herein. According to one embodiment, an email context is extracted from a current email being accessed by a user, the email context including one or more attributes representing certain characteristics of the current email. A related context having a list of one or more documents is automatically presented that are related to the current email based on at least one attribute of the email context. The one or more documents are associated with a prior email having certain characteristics that are similar to those represented by at least one attribute of the email context.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 is a block diagram illustrating a network configuration according to one embodiment of the invention.

FIG. 2 is a block diagram illustrating a system for associating documents with emails based on relevant relationship information according to one embodiment of the invention.

FIG. 3 is a flow diagram illustrating a process for building relationship information based on a user interaction according to one embodiment of the invention.

FIG. 4 is a flow diagram illustrating a process for providing suggestions to an email in view of prior user behaviors according to one embodiment of the invention.

FIG. 5A is a block diagram illustrating a system for constructing relationship information according to one embodiment of the invention.

FIGS. 5B-5D illustrate examples of a data structure which may be used with one embodiment of the invention.

FIG. 6 is a flow diagram illustrating a process for building and rating relationship information based on user behaviors with respect to an email according to another embodiment of the invention.

FIG. 7 is pseudo code for performing a process according to one embodiment of the invention.

FIGS. 8A-8C are screenshots illustrating an example of a graphical user interface (GUI) according to one embodiment of the invention.

FIG. 9 is a block diagram illustrating a data processing system which may be used with an embodiment of the invention.

### DETAILED DESCRIPTION

Mechanisms for associating a remote document with an email based on the most relevant context by a relationship network of users, emails, and documents are described herein. In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

According to certain embodiments, a system is provided which can automatically supply the most relevant documents from a remote server to a local email (inbox) by building, computing, and traversing direct/indirect relationship information among people, inbox (including message thread, message body), and remote documents. In one embodiment, the system monitors and collects user behaviors with respect to a remote document for each incoming message at a mail client. In addition, when a user (e.g., a sender or a recipient) accesses an email the user can explicitly associate (e.g., tagging) the document with the email or an email thread associated with the email. That is, a user can manually relate an email to a document (e.g., a remote document) creating a relationship between the document and the email such that the document will automatically appear at the top of the user's search results, removing the need to attach documents. This can free up bandwidth, email inbox space and allow consistent access to live documents, unlike with a hyperlink, where if the document is moved to a different location, the link is no longer valid. The result of the collection of information is then indexed, evaluated, and constructed into one or more databases stored in data storage to describe relationships of emails, documents, and people. Once such information is built, the system can suggest a list of related documents which are most relevant to the current message context.

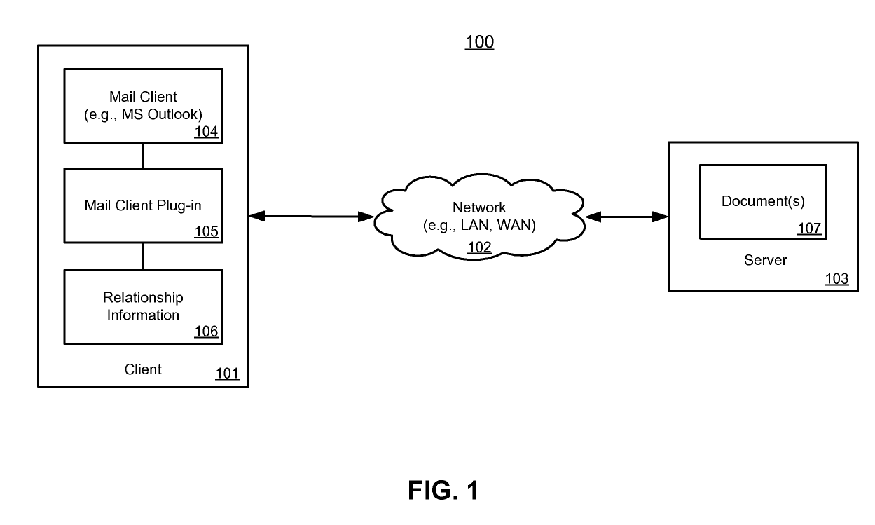

FIG. 1 is a block diagram illustrating a network configuration according to one embodiment of the invention. Referring to FIG. 1, network configuration 100 includes a client 101 communicatively coupled to a server 103 over a network 102. Client 101 can be any kind of computing device, such as, a desktop, a laptop, a personal digital assistant (PDA), etc. Network 102 can be a local area network (LAN), a wide area network (WAN), and can include one or more networks therein. Server 103 can be any kind of server, such as, file server, Web server, and an application server, etc.

In one embodiment, client 101 includes a mail client application 104 (e.g., Outlook™ email client from Microsoft® running therein and a mail client plug-in 105, also referred to as a mail client companion, communicatively coupled to mail client 104. According to one embodiment, mail client plug-in 105 is configured to build up relationship information base 106 among emails, peoples, and documents stored on a server repository (e.g., documents 107 stored in server 103) by collecting, organizing, and processing user behaviors performed on a particular document in a given email context. Subsequently, when a user accesses an email, or composes a new mail, mail client plug-in will automatically suggest a list of related documents based on the relationship information base 106. Therefore, the information would be provided at the finger tip, and the user does not have to search for the related documents outside of the email environment.

For example, when a user opens a newly arrived email from a remote sender, the email including the metadata (e.g., represented by the document segment or URL) referenced to a remote document, the mail plug-in activates the metadata to access the remote document. The mail plug-in 105 includes a processing logic configured to monitor such user interactions and to collect relevant information, including the sender's identity, remote document identity, subject matter of the email, and certain keywords within the email, etc. The processing logic then associates such information with the remote document to create certain relationships between the collected information and the remote document. Such relationship information is stored in storage as part of relationship information base 106. Subsequently, when the user replies or composes a new email to the same sender, mail plug-in 105 may suggest the remote document and other related information so that the user can easily reference the associated document without having to leave the email environment.

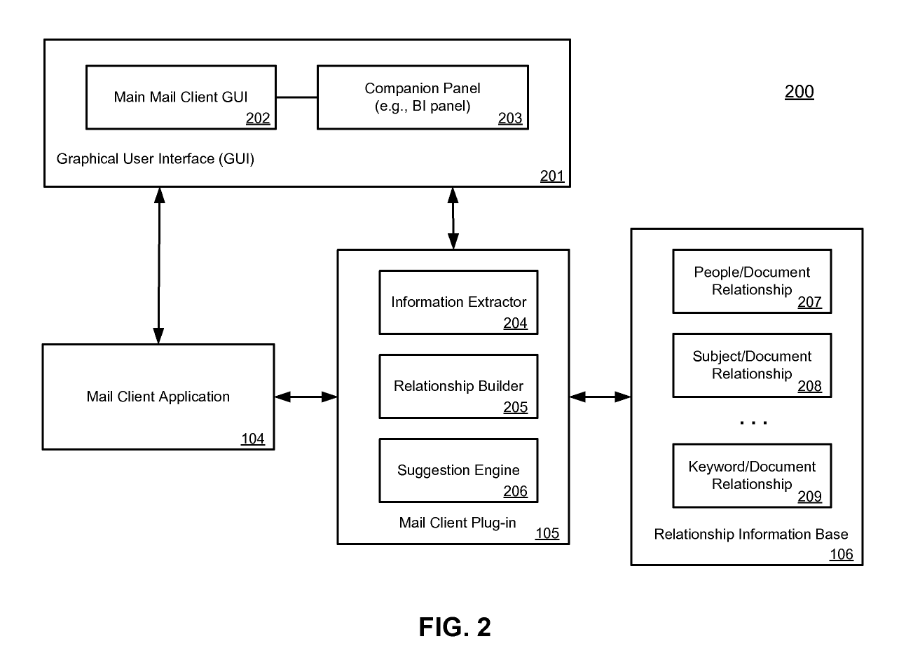

FIG. 2 is a block diagram illustrating a system for associating documents with emails based on relevant relationship information according to one embodiment of the invention. For example, system 200 may be implemented as part of mail client 104, mail plug-in 105, and information base 106 of FIG. 1. For the purpose of illustration, certain reference numbers related to the same or similar components with respect to previously described figures are maintained. Referring to FIG. 2, system 200 includes a mail client application 104, which can be any kind of mail clients such as Microsoft Outlook™ or Lotus Notes™ from IBM, etc. In addition, system 200 includes a mail client plug-in or add-on 105 communicatively coupled to mail client application 104 and relationship information base 106 for storing captured and computed relationship information regarding user behaviors with respect to emails and the associated documents as described above. Information base 106 may be stored locally or remotely over a network.

In one embodiment, mail client plug-in 105 includes an information extractor 204, relationship builder 205, and suggestion engine 206. Information extractor 204 is used to monitor certain user behaviors when the user accesses a particular email and a particular document related to the email, where the document may be accessed locally or remotely. In response, the information extractor 204 is configured to extract certain useful information such as email properties and to identify certain user actions regarding a particular document. Such information is analyzed by relationship builder 205 to build one or more relationship data structures that describe such relationships between the extracted information and the document based on the user action or actions. The data structures are stored in relationship information database 106.

For example, while accessing (reading or writing) an email or meeting request, a user may be referencing a document, for example, stored on a remote server. The user may perform one or more actions on the document, such as, for example, searching/browsing the document, opening and viewing the document, and/or attaching the document in a reply email, etc. In response, information extractor 204 extracts and collects certain types of information associated with the email context, the user action, and the document. Relationship builder 205 is configured to evaluate such information to build an internal data structure which represents the relationships between people, emails, user actions, and documents.

Subsequently, when the user accesses the same or similar email threads, suggestion engine 206 is configured to suggest a list of documents which are most relevant to the given email context based on the relationship information available from relationship information base 106. Thus, in addition to a regular mail client user interface 202 having email context, a companion panel 203 is also displayed in a graphical user interface (GUI) 201. The companion panel 203 is used to present a list of one or more suggested documents that are determined to be related to a particular email and/or the associated email thread currently accessed by the user and presented within the mail client GUI 202.

Similarly, when the user composes an email (or meeting request) to any recipients in the inbox, suggestion engine 206 is also configured to suggest a list of documents which are most relevant to the given email context based on the relationship information available from relationship information base 106. For example, the suggestion engine 206 may suggest to the user the document previously received by the same recipient if the user happened to be part of the same email thread in the past regardless of being the sender, or being one of the recipients.

According to one embodiment, user behaviors (or actions) include, but are not limited to, searching a document by a specific keyword, viewing a document, downloading a remote document to local storage, attaching a document as a mail attachment, and user-defined actions (e.g., specifically tagging a specific email with a specific document), etc. In other words, a user behavior implies a relationship between a particular email (e.g., email context) and a document, which is a building block of the relationship information base behind the scene. To ensure the accuracy and quality, according to one embodiment, a user behavior is assigned with a weight to represent a level of relevance. Different weights may be assigned dependent upon the circumstances, such as, for example, how a document is handled by a user of an email associated with the document. In one embodiment, a weight associated with a user behavior is determined dependent upon a type of user action such as, for example, “Search”, “View”, “Download”, “Attach & Send”, “Received”, and “User-defined” actions, where a “Search” action is assigned with a lowest weight while a “User-defined” action is assigned with a highest weight. For example, if a user conducts a search for particular document, a lower weight is assigned to the associated relationship than a situation when the user downloads the same document. Similarly, when a user explicitly defines (e.g., tagging) a relationship between an email and a document, the highest weight is assigned to the corresponding relationship between the email and the document.

Specifically, according to certain embodiments, information extractor 204 actively monitors and collects all related contextual information for a given email context. In addition to those user behaviors described above, an email context may further include certain email properties, such as, for example, email subject, people involved in the email, attached documents in the email, and/or a keyword. A keyword may be defined by using a data mining tool or textual analysis technology to extract the keywords from an email body or alternatively, by searching keywords defined by a user when the user searches the server repository for data. People may include an email sender and/or recipient.

For example, when a user performs a user action (e.g. open and view a document) while accessing an email, information extractor 204 automatically collects and associates the current contextual information, including “People”, “Subject”, and “Keywords” extracted from the email context, with a “View” action. In addition, when a user attaches a document, inserts the document URL, or inserts a screen capture of the document into an email, the information extractor 204 automatically collects and associates current contextual information, including “People”, “Subject”, and “Keywords” extracted from the email context, with an “Attach” action. Similarly, when a user explicitly creates an association between a remote document and a current email (e.g. tagging), the information extractor 204 automatically collects current email context information including “People”, “Subject”, and “Keywords” and associates such information with a “User Define” action. Furthermore, when the user receives an email, the system automatically checks the email to determine if any document has been previously associated with or attached by the sender. If so, the information extractor 204 collects and associates the current contextual information including “People”, “Subject”, and “Keywords” with a “Receive” action.

Again certain relationships are created without user specific actions, for example, by simply receiving an email having a document attached therein. As described above, a user can also specifically associate a document with an email or an email thread by specifically tagging the document which receives the highest weight. For example, when a user views a document while accessing an email, the system automatically assigns a relationship with a “view” action. After viewing the document, the user specifically tags the document which receives a higher weight for a relationship with the document. As a result, the document may be suggested subsequently having a higher ranking compared to one with only a “view” action. That is, a user can manually relate an email to a document (e.g., a remote document) creating a relationship between the document and the email such that the document will automatically appear at the top of the user's search results, removing the need to attach documents. This can free up bandwidth, email inbox space and allow consistent access to live documents, unlike with a hyperlink, where if the document is moved to a different location, the link is no longer valid.

Once the information extractor 204 collects sufficient information regarding email context and user behaviors, relationship builder 205 is configured to build certain relationships among the collected information (e.g., people, subject, and keyword, etc.) and the associated document or documents, including, for example, people/document relationship 207, subject/document relationship 208, and/or keyword/document relationship 209. Such relationship information is stored as part of relationship information base 106 which may be stored locally within system 200, remotely in a remote server, or both locally and remotely.

The level of participation in an email conversation further defines a relevancy of the relationships, for example, active persons in the “To” list, active persons in the “CC/BCC” list, inactive persons in the “To” list, and inactive persons in the “CC/BCC” list, etc., where a relationship associated with an active person specified in the “To” list has a highest weight while the one with an inactive person specified in the “CC/BCC” list has a lowest weight. In one embodiment, each relationship is assigned or associated with a weight or score representing a relevancy level based on an email context and/or user behaviors in view of a particular email. The weights associated with the relationships between captured information and the documents are used to rank relevancy levels of the relationships. When the documents are suggested in the companion panel 203 by the system, such documents may be presented in an order based on the associated relevancy levels represented by scores calculated based on the corresponding weights of the relationships.

According to one embodiment, relationship builder 205 builds at least two types of relationship information between “people” and “document”: 1) person/document relationship representing a single person in an email having a relationship with a remote document; and 2) group/document relationship representing every recipient in an email is treated as one group having a relationship with a remote document.

Subsequently, when a user receives an email, the information extractor 204 automatically extracts contextual information from the email (also referred to as email context). Suggestion engine 206 is invoked to suggest a list of most relevant documents by searching the relationship information 207-209 stored within database 106 based on the extracted email context information provided by the information extractor 204. The list of suggested documents may be presented in the companion panel 203 and associated with the received email presented in mail client GUI 202. Note that the extracted information provided by the information extractor 204 may also be used by relationship builder 205 concurrently to build or fine tune further relationship information to be stored in database 106 for future usage. Note that some or all of the components as shown in FIG. 2 may be implemented in software, hardware, or a combination of both.

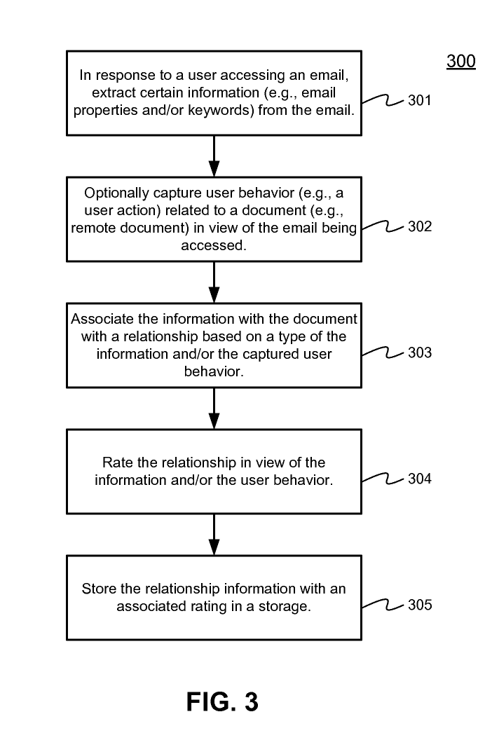

FIG. 3 is a flow diagram illustrating a process for building relationship information based on a user interaction according to one embodiment of the invention. Note that process 300 may be performed by processing logic which may include software, hardware, or a combination of both. For example, process 300 may be performed by system 200 of FIG. 2. Referring to FIG. 3, in response to a user accessing an email, at block 301, certain information is extracted from the email as an email context having one or more attributes representing, for example, email properties (e.g., sender, recipient, subject) and/or one or more keywords extracted from content of the email. At block 302, certain user behaviors related to a document (e.g., accessing a remote document) while accessing the email are captured. At block 303, a relationship is created between at least one attribute of the email context and a document associated with the email based on the email context and/or the captured user behaviors. At block 304, such a relationship is assigned with a weight based on types of the attributes and/or the user behavior. Thereafter, at block 305, the relationship information with the associated weights is stored in storage locally or remotely. Other operations may also be performed.

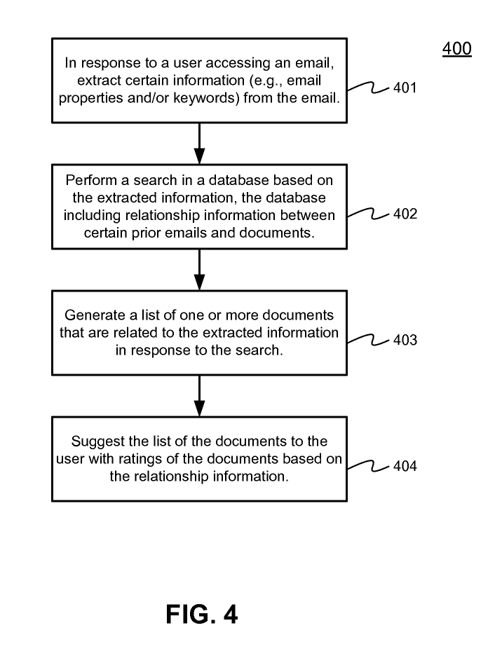

FIG. 4 is a flow diagram illustrating a process for providing suggestions to an email in view of prior user behaviors according to one embodiment of the invention. Note that process 400 may be performed by processing logic which may include software, hardware, or a combination of both. For example, process 400 may be performed by system 200 of FIG. 2. Referring to FIG. 4, in response to a user accessing an email, at block 401, certain information is extracted as an email context from the email, such as, for example, email properties (e.g., sender, recipient, subject, and/or keyword). At block 402, a search is performed in a database based on the extracted information. The database stores relationship information between certain prior emails and certain documents. At block 403, a list of one or more documents are identified and generated that are related to at least a portion of the extracted information from the email context. At block 404, the list of one or more related documents is suggested and presented to the user with ratings of the documents representing a relevancy level of each identified document. Other operations may also be performed.

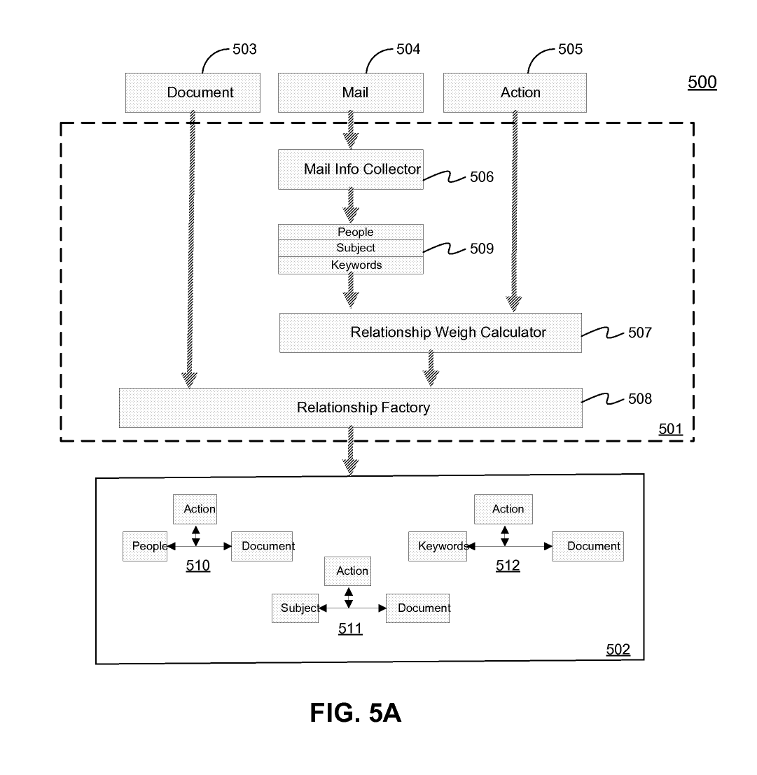

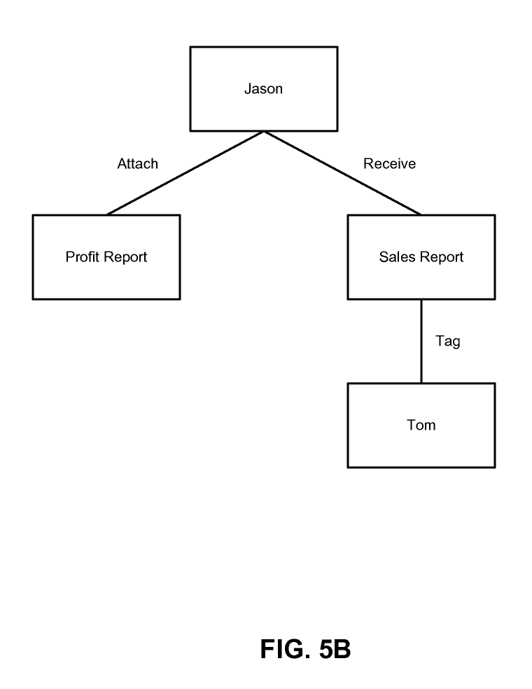

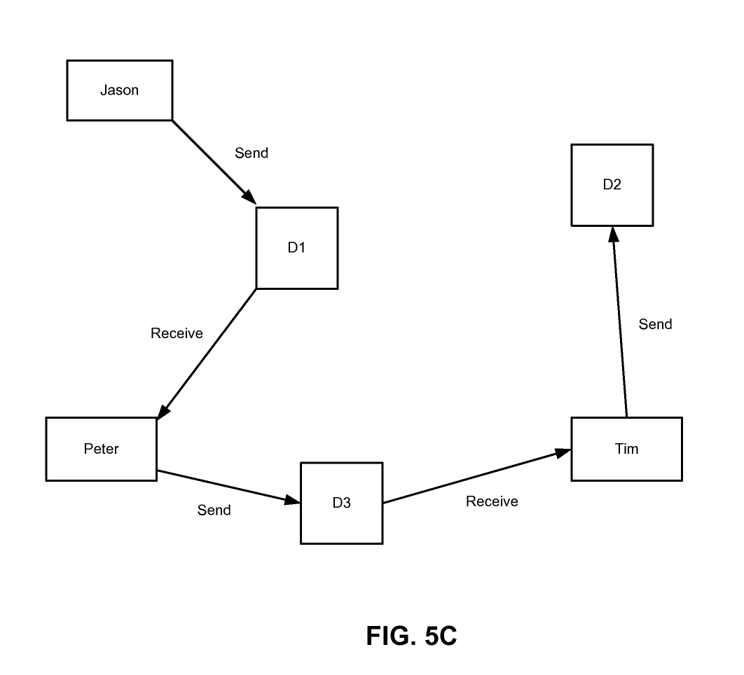

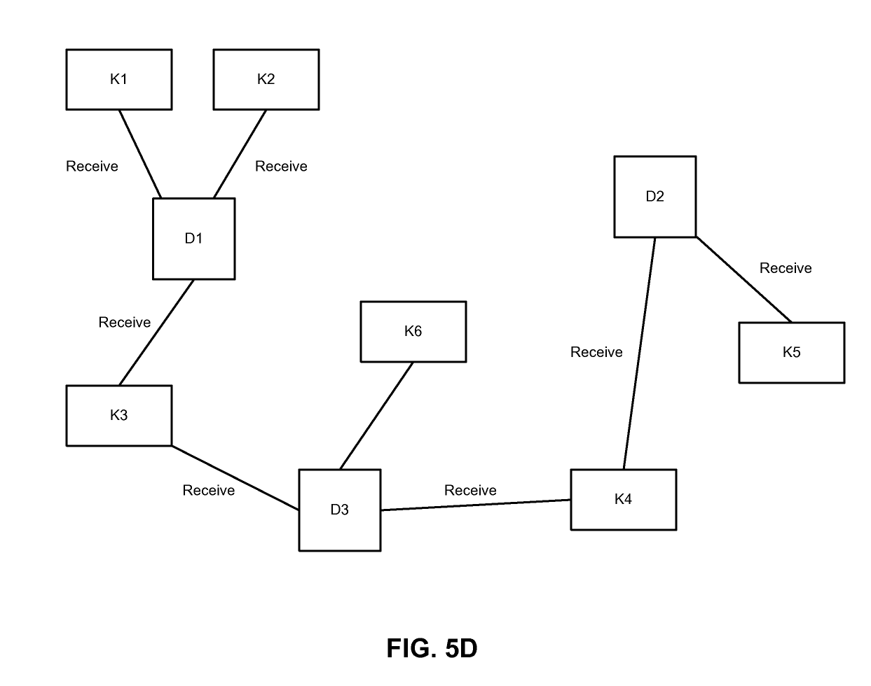

FIG. 5A is a block diagram illustrating a system for constructing relationship information according to one embodiment of the invention. For example, system 500 may be implemented as part of information extractor 204 and relationship builder 205 of FIG. 2. Referring to FIG. 5A, according to one embodiment, system 500 includes a mail companion 501 (e.g., mail plug-in 105) and relationship database 502 (e.g., database 106). Mail companion 501 includes a mail information collector 506 configured to extract information 509 from an email 504 being accessed by a user, such as, for example, “People”, “Subject”, and “Keyword”, etc. In addition, mail component 501 includes a relationship weigh calculator 507 configured to calculate the weight of relevance among people, mail 504, document 503 and user action 505. Mail component 501 further includes a relationship factory 508 configured to build up relationship information among people, email, actions, remote documents and its weight of relevance. The relationship information is stored in a variety of data structures 510-512 in database 502.

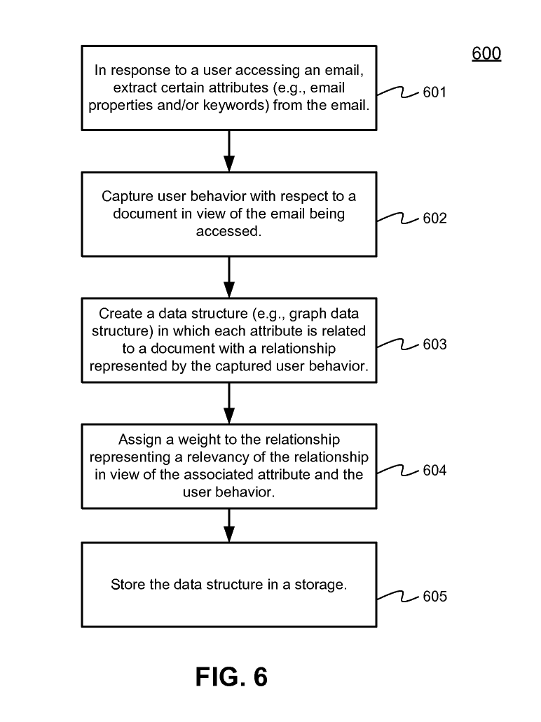

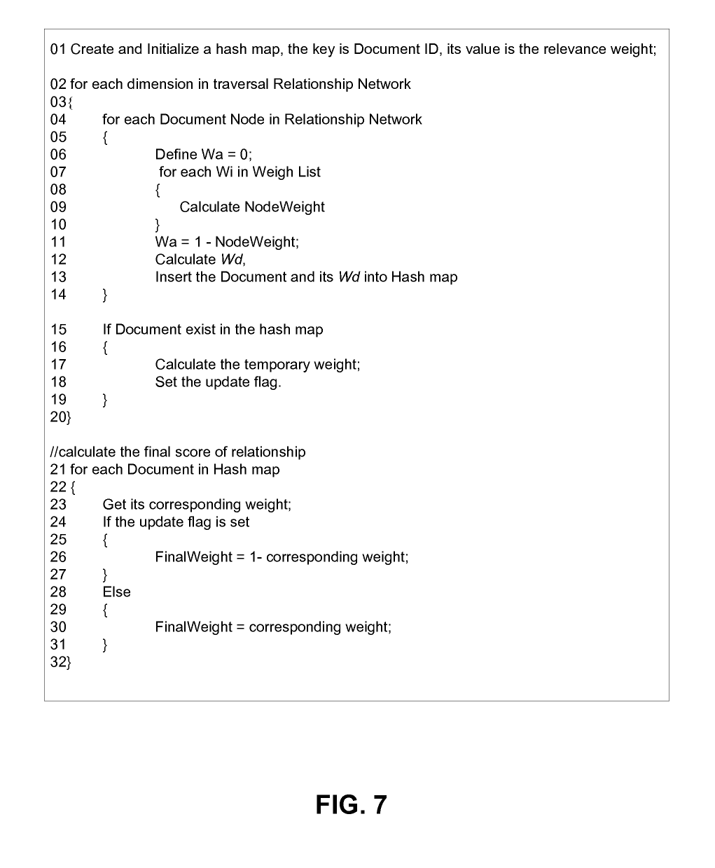

FIG. 6 is a flow diagram illustrating a process for building and rating relationship information based on user behaviors with respect to an email according to another embodiment of the invention. Note that process 600 may be performed by processing logic which may include software, hardware, or a combination of both. For example, process 600 may be performed by system 500 of FIG. 5A. Referring to FIG. 6, in response to a user accessing an email, at block 601, certain information is extracted from the email, such as, for example, email properties (e.g., sender, recipient, subject, and/or keyword). At block 602, certain user behaviors related to a document (e.g., accessing a remote document) while accessing the email are captured. At block 603, a data structure is created in which each piece of information (e.g., email property) is related to a document with a relationship represented by the captured user behavior or action. At block 604, a weight or score is assigned to the relationship representing a relevancy of the relationship in view of the associated attribute and the user behavior and thereafter, at block 605, the data structure is stored in a database. Other operations may also be performed. Note that a weight associated with a relationship is assigned and stored when the relationship is stored in the database. Subsequently, when a document is searched and identified in the database in view of a new email, a score (e.g., rating) is calculated based on the weights associated with the document in view of the email context (e.g., email property or keywords) of the new email, where the score represents a level relevancy of the identified document with respect to the new email. FIG. 7 is pseudo code for computing a score (or rating) based on the assigned weight representing a level of relevance to determine the most relevant document for a user.

According to one embodiment, examples of the weight of relevance between the user behaviors and the contextual information are defined as follows:

| | | Send/Attach | Receive | |
|---|---|---|---|---|
| | View (V) | (A) | (R) | Tag (T) |
| People (P) | PV = 0.2 | PA = 0.9 | PR = 0.9 | PT = 0.9 |
| Subject (S) | SV = 0.2 | SA = 0.8 | SR = 0.8 | ST = 0.9 |
| Keywords | KV = 0.1 | KA = 0.6 | KR = 0.6 | KT = 0.8 |
| (K) | | | | |

Each relationship may be stored in a data structure which may be linked to other relationships with respect to the associated document. In one embodiment, a graph data structure is utilized herein. A graph is a type of data structure, specifically an abstract data type (ADT) that consists of a set of nodes (also called vertices) and a set of edges that establish relationships (connections) between the nodes. The ADT graph follows directly from the graph concept from mathematics. Informally, G=(V,E) consists of vertices, the elements of V, which are connected by edges, the elements of E. Formally, a graph, G, is defined as an ordered pair, G=(V,E), where V is a set (usually finite) and E is a set consisting of two element subsets of V.

In one embodiment, the system uses an adjacency list to represent a graph data structure. An adjacency list is implemented by representing each node as a data structure that contains a list of all adjacent nodes. In this example, the system defines “People”, “Mail Subject”, “Keywords”, and “Documents” as nodes of the graph. The “Action” and its weight of relevance is an edge of these nodes. The system builds the relationship network into three dimensions including:
People/Document relationship
Subject/Document relationship
Keyword/Document relationship
   These three dimensional data structures have different weights on calculating the relationship relevance in a suggestion algorithm.

A single relationship item includes two nodes and one edge. For example, in a People/Document relationship, the item consists of two nodes (e.g., person and document) and one edge (e.g., action). Its value could be “Tom”, “Sales Report”, “Attach”, which represents that Tom has a direct relationship with document of “Sales Report” from attaching it to an email. The weight of this relationship is based on the edge of “Attach”.

The entire relationship network builds up a network between people and documents. For example, a network has certain items: 1) “Jason”, “Sales Report”, and “Receive”; 2) “Jason”, “Profit Report”, and “Attach”; and 3) “Tom”, “Sales Report”, and “Tag”. This implies that “Tom” has an indirect relationship with document “Profit Report”. The relationship is linked by the person “Jason” and the document “Sales Report” as shown in FIG. 5B. In addition, these types of “networks” can also be found between Subject-Documents and Keywords-Documents.

In an embodiment of the invention, the system builds up a whole network of relationships with three dimensions. For example, as shown in FIG. 5C, it is assumed that Jason sends an email to a current user and another user Peter having a document D1 attached therein. Subsequently, another user Tim sends the current user an email having a document D2 attached therein, and Peter sends the current user and Tim another email with a document D3 attached therein. The relationship network built by the system will be similar to the one as shown in FIG. 5C. If the current user prepares a new email to be sent to Jason, the suggestion engine may suggest documents in an order of D1, D3, and D2, which scores are calculated by the length of a traversal path and their respective weights.

In another example, as shown in FIG. 5D, it is assumed that a user once received an email having a document D1 and keywords K1, K2, and K3 therein. Subsequently, the user received another email having a document D2 and keywords K4 and K5 therein. Further, the user also received another email having a document D3 and keywords K3, K4, and K6 therein. The relationship network built by the system will be similar to the one as shown in FIG. 5D. In this situation, if the user prepares a new email having a keyword K1, the suggestion engine may suggest documents in an order of D1, D3, and D2 with the associated scores.

In one embodiment, an input of a suggestion engine includes certain email properties extracted from an email including “People”, “Subject”, and “Keywords”. An output of the suggestion engine includes a list of related documents with relevance weight or suggestion score. In an embodiment of the invention, the suggestion engine traverses every node in the relationship network and calculates the weight of the relevance of the documents on each network node. According to one embodiment, the nodes of the database are traversed in a breadth-first search algorithm. According to one embodiment, any node in the database can be a starting point dependent upon a search term, which could be any one of “People”, “Subject”, and/or “Keyword.” Each node along a traversal path corresponds to one or more related documents and the depth (or length) of the traversal has an impact on the score calculation. After retrieving a list of scored documents from different dimensions separately, the system consolidates these related documents to compute the final list of documents and their corresponding weights.

According to one embodiment, a weight of a node may be calculated using an equation set forth below:

$$Wa = 1 = {\prod }_{1}^{M} [ {\prod }_{1}^{N} ( 1 - Wi ) ] \qquad Eq . 1$$

where Wi (1≦i≦N, 1≦i≦M) is the edge weight of the relevance, for example, defined by the table set forth above. N is a count of the same actions on the remote documents. For example, the same sender may attach the same documents for several times in different mail threads. M is a count of actions type, for example, defined by the table set forth above. For example, the same documents may be viewed and attached for several times under certain contexts.

The node weight may be adjusted using an equation set forth below:

Wd=Wa*Fₛ Eq. 2

where S is a depth of the node on the graph when traversing the whole graph data structure. F (0<F<1) is a constant value of an adjusting factor. Wd is the weight of the document relevance in each dimension traversal.

The final weight can be determined as follows:

$$W = 1 - {\prod }_{1}^{N} ( 1 - Fi * Wdi ) \qquad Eq . 3$$

where W is the final weight of the document relevance. Wdi (1≦i≦N, 1≦i≦M) is the weight calculated by Eq. 2 for each dimension. The dimensions include “People”, “Subject”, “Keywords”, etc. Fi (0<Fi<1, 1≦i≦N, 1≦i≦M) is the adjusting factor for each dimension.

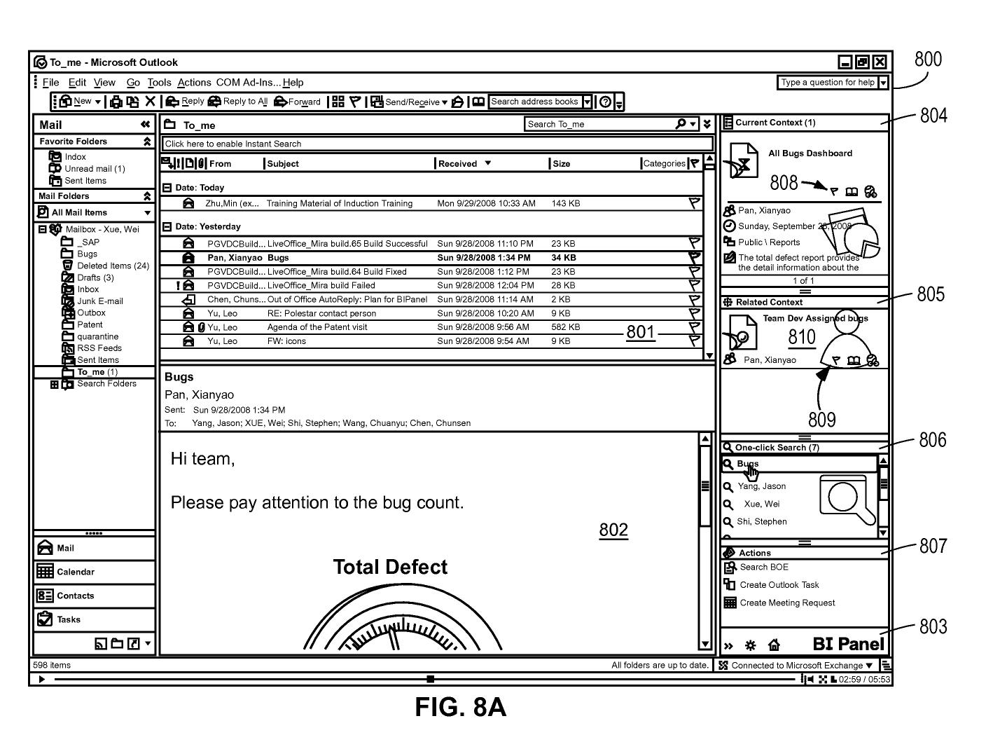

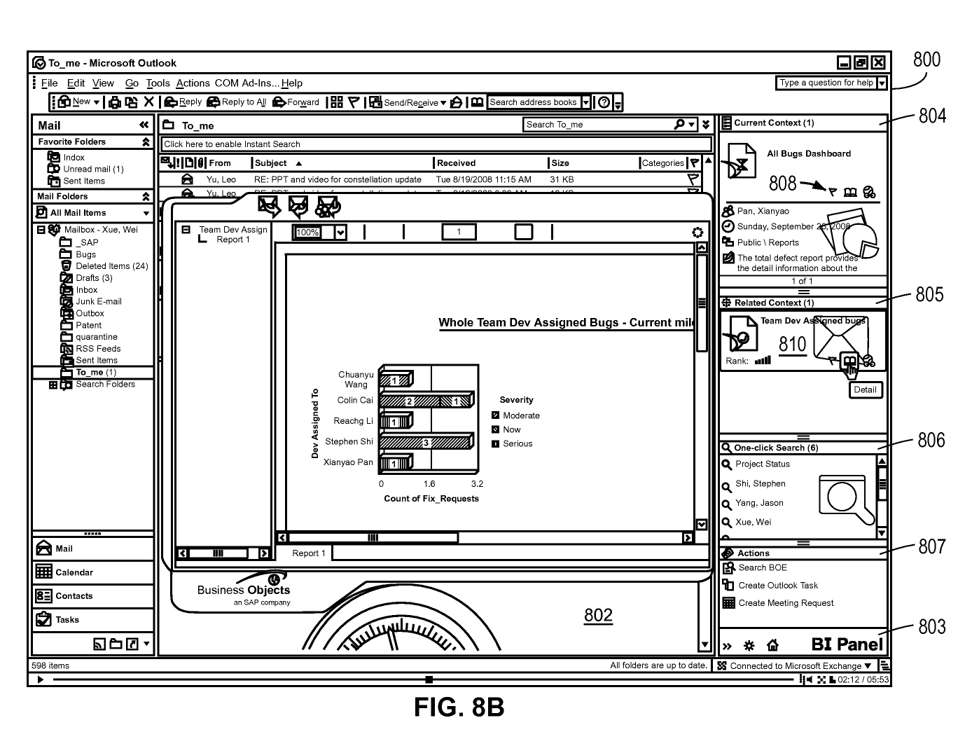

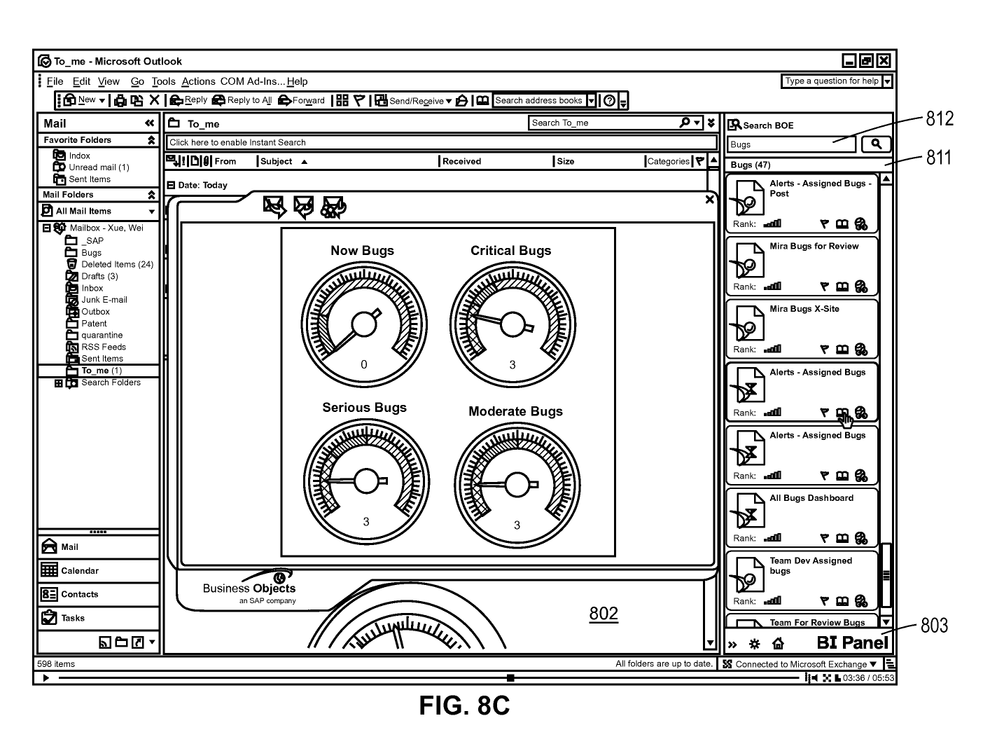

FIGS. 8A-8C are screenshots illustrating an example of graphical user interface (GUI) of a system according to one embodiment of the invention. Note that although GUI 800 is shown herein as part of Microsoft Outlook™ mail client, features illustrated herein can also be applied to a variety of mail client applications such as Lotus Notes™ from IBM, etc. Referring to FIG. 8A, similar to any mail client, GUI 800 includes a main window having a first display area 801 for listing emails of a particular folder (in this example, an Inbox) and a preview area 802 for preview a particular email selected from window 801. Note that detailed information of a particular email may be displayed in a larger view in a separate window (e.g., pop-up window), for example, by double-clicking the corresponding email.

In addition, according to one embodiment, in response to selecting an email from window 801, an email companion panel 803 is presented for displaying any related information that is related to the selected email using some or all of the techniques described above. For example, some or all of the information displayed within panel 803 may be selected or identified based on certain user actions performed on a related email or emails, which have been analyzed, ranked, and/or stored by processing logic (e.g., system 200) in an underlying database.

As described above, when a user selects an email from window 801, processing logic (e.g., information extractor) automatically extracts certain information from the selected email context (e.g., sender, recipient, subject, or certain keywords etc.) and (suggestion engine) performs a search in a database that stores relationship information. A list of related items or documents is generated and presented in the panel 803.

Referring back to FIG. 8A, panel 803 includes a current context window 804 for displaying information generated from content of the selected email, such as, for example, a list of one or more documents currently associated with the selected email. In this example, it is assumed that document “All Bugs Dashboard” is associated (e.g., linked or attached) with the email displayed in window 802. The system extracts the document from the email and displays metadata associated with the document in the current context area 804 including, for example, an author of the document, a storage path of the document, and/or a summary of the document, etc. In addition, one or more controls or buttons 808 are associated with each item displayed in window 804 to allow a user to further navigate or perform additional action regarding the associated item. In one embodiment, buttons 808 include a “flag” button to allow a user to specifically tag the associated item (e.g., document “All Bugs Dashboard” in this example) with the selected email displayed in window 802. By tagging the document, a relationship between the document and certain context information of the email is created having a “User-defined” action associated therein. In addition, buttons 808 further include a “detail” button to view the detailed information of the associated document. Furthermore, buttons 808 further include a “link” button, which when activated, invokes an alternative viewer such as a viewer as part of an Enterprise backend system (not shown) to view the detailed information of the document.

In addition, panel 803 includes a related context window 805 to display a list of one or more items (e.g., documents) that are related to the selected email from window 801. Such items displayed within window 805 are suggested by a suggestion engine (not shown) based on user prior behaviors regarding certain prior related emails and/or documents as described above. For example, as described above, when an email is selected, email context information is extracted from the selected email, including certain email properties and/or one or more keywords extracted from content of the selected email. At least a portion of the extracted email context is used as one or more search terms to search in a relationship database to automatically generate a list of suggested documents as part of related context 805 based on certain prior related emails having certain characteristics similar to those represented by the extracted email context. Similarly, one or more controls or buttons 809 are associated with each item displayed in window 805 to allow a user to further navigate or perform additional actions regarding the associated item.

In this example, there is one related item 810 having buttons or controls 809 associated therein. A user can specifically tag the related item 810 by activating a “flag” button which specifically defines a relationship as a “user-defined” category having a highest weight. Note that as described above, any user action within GUI 800 may be captured and analyzed dynamically by a underlying logic (e.g., information extractor or collector, relationship builder, and/or suggestion engine) to build further relationship information or provide further suggestions substantially concurrently. The user may further view the details of the related item 810 by activating a “detail” button as shown in FIG. 8B.

GUI 800 further includes a quick search window 806 which is used to display a list of keywords that are extracted from the currently selected email, such as, for example, subject, sender, recipient, and/or certain keywords from the content of the email. Any of the keywords displayed in window 806 can be used as a search term for launching a quick search. For example, by selecting a keyword such as “bugs” in window 806, a search is conducted (e.g., in an email server, or other servers such as enterprise servers) and a search result is displayed in a search result window as shown in FIG. 8C.

Referring to FIG. 8C, each item displayed in search result window 811 in panel 803 can be selected to tag or view as described above. In addition, a user can perform a further search by entering another keyword or keywords in an input field 812. Referring back to FIG. 8A, panel 803 further includes an action window listing a list of common actions which may be defined system wide or by the user individually, such as, for example, conducting a search (e.g., FIG. 8C), creating a task to be performed, or scheduling a meeting related to the selected email. Again, any such user actions may also be monitored and captured for further analysis in order to generate further relationship information for future suggestions. Note that an email client has been used as an example throughout this application, however, the techniques described above can also be applied to other applications, such as, for example, instant message frameworks or network discussion forums.

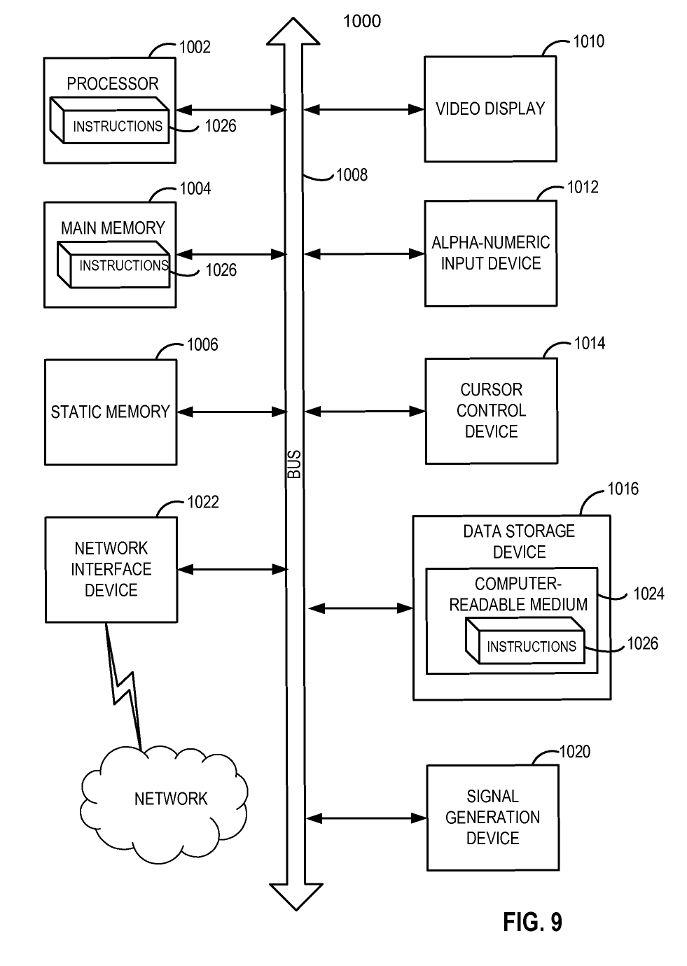

FIG. 9 is a block diagram illustrating a data processing system which may be used with an embodiment of the invention. For example, system 1000 may be implemented as part of a client and/or a server as described above. System 1000 illustrates a diagrammatic representation of a machine in the exemplary form of a computer system within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1000 includes a processing device (processor) 1002, a main memory 1004 (e.g., read-only memory (ROM), flash memory, dynamic random access memory (DRAM) such as synchronous DRAM (SDRAM) or Rambus DRAM (RDRAM), etc.), a static memory 1006 (e.g., flash memory, static random access memory (SRAM), etc.), and a data storage device 1016, which communicate with each other via a bus 1030.

Processor 1002 represents one or more general-purpose processing devices such as a microprocessor, central processing unit, or the like. More particularly, the processor 1002 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1002 may also be one or more special-purpose processing devices such as an application specific integrated circuit (ASIC), a field programmable gate array (FPGA), a digital signal processor (DSP), network processor, or the like. The processor 1002 is configured to execute instructions 1026 for performing the operations and steps discussed herein.

The computer system 1000 may further include a network interface device 1022. The computer system 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse), and a signal generation device 1016 (e.g., a speaker).

The data storage device 1016 may include a machine-accessible storage medium 1030 on which is stored one or more sets of instructions 1026 (e.g., software) embodying any one or more of the methodologies or functions described herein. The software may also reside, completely or at least partially, within the main memory 1004 and/or within the processor 1002 during execution thereof by the computer system 1000, the main memory 1004 and the processor 1002 also constituting machine-accessible storage media. The software may further be transmitted or received over a network via the network interface device 1022.

Thus, mechanisms for associating a remote document with an email based on the most relevant context by a relationship network of users, emails, and documents have been described herein. Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable medium. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description above. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method, the method comprising:
extracting an email context from a current email being accessed by a user, the email context including one or more attributes representing certain characteristics of the current email; and
automatically presenting to the user a related context having a list of one or more documents that are related to the current email based on at least one attribute of the email context, wherein the one or more documents are associated with a prior email having certain characteristics that are similar to those represented by at least one attribute of the email context.

2. The method of claim 1, further comprising searching in a database using at least one attribute of the email context as one or more search terms to identify the one or more documents, the first document having a relationship with at least one of the search terms, wherein the relationship was created and stored in the database when the user accessed the prior email.

3. The method of claim 2, wherein a prior email context was extracted from the prior email when the user accessed the prior email, wherein an action performed by the user with respect to the one or more documents was captured when the user accessed the one or more documents associated with the prior email, and wherein a relationship was created between at least one attribute of the prior email context and the one or more documents based on the captured action.

4. The method of claim 3, further comprising calculating a score for each of the one or more documents representing a relevancy level of each document with respect to the current email, wherein the score is determined based on a weight assigned to each relationship between the at least one attribute and each document, and wherein the one or more documents are listed according to an order based on scores associated with the one or more documents.

5. The method of claim 3, wherein the email context and prior email context include one or more attributes representing at least one of a sender identifier, a recipient identifier, a subject matter, and a keyword of the current email and prior email.

6. The method of claim 5, wherein the action includes one of viewing, attaching, receiving, downloading, and tagging the one or more documents.

7. The method of claim 1, further comprising:
displaying the current email in a first window; and
displaying a second window as an email companion window, the email companion window listing the one or more documents that are related to the current email, wherein the one or more documents are listed based on levels of a relevancy with respect to the current email.

8. The method of claim 1, further comprising:
in response to the user accessing a document while accessing the current email, capturing a user action with respect to the document; and
creating a new relationship between at least one attribute of the current context and the document;
assigning a weight representing a strength of a relevance to the new relationship based on a type of the at least one attribute and the captured user action; and
storing the new relationship with the assigned weight in the database such that when the user accesses a future email, the document can be identified and presented to the user based on the new relationship.

9. The method of claim 8, further comprising associating the new relationship with a graph data structure having a first node and a second node coupled to the first node via an edge, wherein the first node represents the at least one attribute; the second node represents the document; and the edge represents the user action.

10. The method of claim 8, wherein creating the new relationship and presenting the one or more documents are performed substantially concurrently.

11. A machine-readable storage medium having instructions stored therein, which when executed by a machine, cause the machine to perform a method, the method comprising:
extracting an email context from a current email being accessed by a user, the email context including one or more attributes representing certain characteristics of the current email; and
automatically presenting to the user a related context having a list of one or more documents that are related to the current email based on at least one attribute of the email context, wherein the one or more documents are associated with a prior email having certain characteristics that are similar to those represented by at least one attribute of the email context.

12. The machine-readable storage medium of claim 11, wherein the method further comprises searching in a database using at least one attribute of the email context as one or more search terms to identify the one or more documents, the first document having a relationship with at least one of the search terms, wherein the relationship was created and stored in the database when the user accessed the prior email.

13. The machine-readable storage medium of claim 12, wherein a prior email context was extracted from the prior email when the user accessed the prior email, wherein an action performed by the user with respect to the one or more documents is captured when the user accessed the one or more documents associated with the prior email, and wherein a relationship was created between at least one attribute of the prior email context and the one or more documents based on the captured action.

14. The machine-readable storage medium of claim 13, wherein the method further comprises calculating a score for each of the one or more documents representing a relevancy level of each document with respect to the current email, wherein the score is determined based on a weight assigned to each relationship between the at least one attribute and each document, and wherein the one or more documents are listed according to an order based on scores associated with the one or more documents.

15. The machine-readable storage medium of claim 13, wherein the email context and prior email context include one or more attributes representing at least one of a sender identifier, a recipient identifier, a subject matter, and a keyword of the current email and prior email.

16. The machine-readable storage medium of claim 15, wherein the action includes one of viewing, attaching, receiving, downloading, and tagging the one or more documents.

17. The machine-readable storage medium of claim 11, wherein the method further comprises:
displaying the current email in a first window; and
displaying a second window as an email companion window, the email companion window listing the one or more documents that are related to the current email, wherein the one or more documents are listed based on levels of a relevancy with respect to the current email.

18. The machine-readable storage medium of claim 11, wherein the method further comprises:
in response to the user accessing a document while accessing the current email, capturing a user action with respect to the document; and
creating a new relationship between at least one attribute of the current context and the document;
assigning a weight representing a strength of a relevance to the new relationship based on a type of the at least one attribute and the captured user action; and
storing the new relationship with the assigned weight in the database such that when the user accesses a future email, the document can be identified and presented to the user based on the new relationship.

19. The machine-readable storage medium of claim 18, wherein the method further comprises associating the new relationship with a graph data structure having a first node and a second node coupled to the first node via an edge, wherein the first node represents the at least one attribute; the second node represents the document; and the edge represents the user action.

20. The machine-readable storage medium of claim 18, wherein creating the new relationship and presenting the one or more documents are performed substantially concurrently.

21. A computer-implemented method, comprising:
automatically extracting a first context from a first email being accessed by a user, the first context including one or more attributes representing certain characteristics of the first email;
in response to the user accessing a document while accessing the first email, capturing a user action associated with accessing the document;
automatically associating at least one attribute of the first context with the document to create a relationship in view of the captured user action; and
storing the relationship in a database, such that when the user subsequently accesses a second email having similar characteristics of the first email, the document can be identified and suggested to the user based on the relationship stored in the database.

22. A computer-implemented method, comprising:
automatically extracting an email context from a current email displayed in a first window being accessed by a user, the current context including one or more attributes representing certain characteristics of the current email;
generating a list of one or more documents that are related to the current email based on the email context, wherein the one or more documents are associated with a prior email having certain characteristics that are similar to those represented by at least one attribute of the email context; and
displaying a second window as an email companion window, the email companion window listing the one or more documents that are related to the current email displayed in the first window based on the email context.

23. The method of claim 22, further comprising:
displaying metadata of a document currently associated with the current email in a current context area within the email companion window;
displaying the list of the one or more documents related to the current email in a related context area within the email companion window, wherein the one or more documents are listed according to an order based on relevant levels of the one or more documents, wherein the relevant levels are determined based on a type of user behaviors regarding the one or more documents while accessing the prior email; and
in response to selecting a specific document listed within the related context area, displaying content of the selected document in a third window.
